(19) United States
(12) Patent Application Publication
(10) Pub. No.: US 2009/0040001 A1
(43) Pub. Date: Feb. 12, 2009

(54) POWER CONVERTER

(76) Inventors: George Young, County Dublin (IE); Peter Michael Meaney, County Cork (IE)

Correspondence Address: HOLLAND & KNIGHT LLP, 10 ST. JAMES AVENUE, 11th Floor, BOSTON, MA, 02116-3889, US

(21) Appl. No.: 12/089,748

(22) PCT Filed: Oct. 10, 2006
(86) PCT No.: PCT/EP2006/067247

§ 371 Date: Oct. 20, 2008

(30) Foreign Application Priority Data
Oct. 10, 2005 (IE) S2005/0684

(51) Int. Cl. H01F 27/28; H01F 27/34; H01F 3/14

(52) U.S. Cl. 336/223; 336/69; 336/178

(57) ABSTRACT

The invention relates to a power converter (1) comprising a magnetic core (3) and a plurality of sub-converters each having a primary winding (17, 19) and a secondary winding. The magnetic core (3) comprises an inner leg (7) and a plurality of outer legs (5, 9), each of the outer legs (5, 9) having a gap (11, 13) formed therein. The primary winding (17) of one sub-converter is wound around an outer leg and the primary winding (19) of another sub-converter is wound around another outer leg. The primary windings (17, 19) are formed from a unitary winding (21) which is wound around the legs (5, 7, 9) in a continuous fashion. The primary windings (17, 19) are mounted on a printed circuit board (PCB) (15) and interconnects between turns of the primary windings are achieved using vias (27, 29) at the ends (23, 25) of the unitary winding. The vias may be conveniently placed in the corner sections or the PCB (15).

This invention relates to a power converter comprising a plurality of sub-converters and a magnetic core, the plurality of sub-converters each having a primary winding and a secondary winding, the magnetic core further comprising an E-core having a first end leg, a centre leg and a second end leg, both the first and second end legs having a gap formed therein.

Power converters have been Known for a long time and are used to transform an input voltage, which may be a mains supply voltage or other power supply voltage into an output voltage more suitable for a particular load to be driven by the power converter. Typically, power converters may be used to transform the input mains voltage into voltages suitable for use with integrated circuits and other electronic equipment. Other power converters are used to transform a DC intermediate drive voltage. Heretofore, there have been many different topologies used for effecting the power conversion. One particularly useful approach has been the usage of interleaved flyback converters with series connected primary windings. Another suitable approach other than the interleaved flyback converter approach is the current doubler approach. Both of these approaches are seen as effective and efficient for use with power converters.

One feature of both of these approaches, is that converters with such topologies can be implemented using two magnetic elements. These magnetic elements may be combined quite readily into a single E-core where there is a gap in each outer leg and the centre leg has no gap. In the implementation of such a converter, it is important that there is minimal leakage inductance between the primary and secondary windings. In order to achieve this, the windings are interleaved so that the primary and secondary windings physically overlap to the maximum extent possible. This typically requires that the primary and secondary windings associated with each stage are wound around the outer leg in the E-core implementation with windings interleaved using planar or foil winding techniques as appropriate particularly for low voltage high current implementations.

There have been provided various converters in which there is supplied a primary winding around each leg with the windings then connected in series with respect to each other. However there are numerous difficulties with such an implementation. Typically, this implementation requires additional interconnects between layers of a winding. These are usually implemented using via holes placed in the printed circuit board (PCB). However placement of via holes is very difficult and it is important to maintain agency-mandated spacings between input and output connections in the converter. A partial solution involves the use of buried and/or blind vias. This however is undesirable due to the addition of extra processing steps in the manufacture of the PCB which further increases the cost of the PCB fabrication process,

Another problem with the known implementations of converter such as those described above, and in particular implementations with half-bridge primary excitation, is that these implementations are unbalanced in the context of generating common-mode electromagnetic interference (EMI). In a common mode noise management sense it is very desirable that a balanced condition exists so that the net common mode current flowing is minimised. One solution that has been suggested is to provide dummy noise-cancelling windings in either printed circuit board transformer implementations or in implementations using wound transformers. Although effective, this implementation takes up significant space within a transformer which is highly undesirable in the modern age of minimisation of electronic components in general. Having dummy windings whose sole purpose is for noise cancellation and which do not carry current can also add to leakage inductance in the converter. By providing additional dummy windings, the space provided for active current carrying windings is reduced thereby necessitating smaller active windings which are inherently more resistive which adds to the overall losses and reduces the efficiency of the converter.

Finally, a further requirement of these power converters is that there is no sinking of current from the output during start-up. This requires that synchronous rectifier elements are controlled in such a manner that they do not turn on until the output is at some figure between typically 70% and 100% of the output voltage. Control circuits to implement this “pre-bias” start-up as it is commonly referred to, are typically complex and costly to manufacture.

It is an object therefore of the present invention to provide a power converter that overcomes at least some of these difficulties that is relatively simple and cost effective to manufacture and that is also relatively small and flexible in operation.

### STATEMENTS OF INVENTION

According to the invention there is provided a power converter comprising a plurality of sub-converters and a magnetic core, the plurality of sub-converters each having a primary winding and a secondary winding, the magnetic core further comprising an inner leg and a plurality of outer legs, each of the plurality of outer legs having a gap formed therein, characterised in that the primary winding of one of the sub-converters is wound around one of the outer legs and the primary winding of another sub-converter is wound around another of the outer legs, the primary windings being formed from a unitary winding of conductive material.

By having such a power converter, the construction and manufacture of the power converter will be significantly simplified which will allow for the power converter to be manufactured in a highly cost effective manner. The primary windings of the power converter are effectively in series on a turn by turn basis. This results in a significant reduction in the number of interconnects required in the power converter construction process which has the direct effect of simplifying the manufacturing and fabrication process of the power converter and thereby reducing the cost of manufacturing the power converter. Furthermore this facilitates compliance with agency mandated spacings for input and output connections in the converter and the power converter will be both compact and relatively efficient in operation.

In one embodiment of the invention there is provided a power converter in which the primary windings of a plurality of the sub-converters each comprise a plurality of turns, each turn of one of the sub-converters being formed from a unitary winding of conductive material with a corresponding turn of another sub-converter, each turn of the sub-converter being connected to another turn of that sub-converter by way of an interconnect, thereby connecting the primary windings of the pair of sub-converters in series on a turn-by-turn basis. By having such a power converter, the turns are connected in series on a turn by turn basis and it is only necessary to have an interconnect between the turns that are in series with the other turns of the power converter. This significantly reduces the number of interconnects that are needed in the power converter which reduces the complexity of manufacture of the power converter and partially overcomes the problem of placement of interconnects in such a power converter.

In another embodiment of the invention there is provided a power converter in which the power converter further comprises a printed circuit board (PCB) and the primary windings are constructed using planar techniques. This is seen as a particularly preferred embodiment of the invention. In this way, the power converter windings may be provided in a very controlled and precise manner and the placement of the interconnects may be achieved in a relatively straightforward manner. The windings may be implemented by etching a conductive material or deposition of a conductive material on a suitable substrate.

In a further embodiment of the invention there is provided a power converter in which each end of the unitary winding of conductive material terminates in a vias. Once again, this allows for the simple placement of vias and a more simplified interconnection between layers and more specifically different winding turns in the PCB.

In one embodiment of the invention there is provided a power converter in which the vias are located in a corner location of the PCB. This is seen as particularly advantageous as by having the vias in a corner location, the interconnection between layers will be further simplified which reduces the cost of manufacture of the power converter.

In another embodiment of the invention there is provided a power converter in which the magnetic core further comprises an E-core having a first outer leg, an inner leg and a second outer leg. This is seen as a simple construction of power converter in which the present invention may be implemented. The E-core may be implemented by forming the gaps in the outer legs or alternatively it is possible to create such a core by abutting a planar section up against an extended centre post.

In a further embodiment of the invention there is provided a power converter in which the unitary winding of conductive material is led around the first outer leg in a first orientation, back between the first outer leg and the inner leg, around the inner leg in the opposite orientation to the first orientation, back between the inner leg and the second outer leg and around the second outer leg in the first orientation. It is envisaged that the first orientation may be anticlockwise and the second orientation may be clockwise or vice versa. This is a simple winding structure that will allow the present invention to be implemented in a relatively straightforward manner that will also be manufactured in a relatively simple manner. The winding structure will allow for the placement of vias in a corner location of the PCB if desired.

In one embodiment of the invention there is provided a power converter in which the unitary winding of conductive material substantially surrounds each of the outer legs.

In another embodiment of the invention there is provided a power converter in which the magnetic core further comprises a star configuration core in which there are provided three or more outer legs and an inner leg, the outer legs being evenly spaced from the inner leg and symmetrically spaced around the inner leg with respect to each other. This is also seen as a useful construction of magnetic core for a power converter according to the present invention.

In a further embodiment of the invention there is provided a power converter in which the unitary winding of conductive material is wound around each of the outer legs and the inner leg, the unitary winding being wound at least partially around the inner leg between being wound around a pair of outer legs.

In one embodiment of the invention there is provided a power converter in which the unitary winding of conductive material substantially surrounds each of the outer legs.

In another embodiment of the invention there is provided a power converter in which the power converter is further provided with means to manage common mode noise, the means comprising a dummy winding having at least one turn, the turn being connected to a neutralising capacitive element. This is seen as a relatively simple way to minimise the common mode noise that is created in such a power converter.

In a further embodiment of the invention there is provided a power converter in which the dummy winding has a number of turns comparable to the number of turns of the primary winding of a sub-converter of the power converter.

In one embodiment of the invention there is provided a power converter in which the turn of the dummy winding is placed around the inner leg of the magnetic core. This is seen as a particularly compact way of providing the dummy winding. By having the dummy winding placed around the inner leg of the magnetic core, it will not necessarily cause a reduction in the size of the active windings of the converter and therefore will not be inclined to add to the overall fosses in the converter and reduce efficiency. Furthermore, the positioning of the dummy winding about the inner leg will also not be inclined to increase the leakage inductance of the power converter when compared with implementations having the dummy winding surrounding an outer leg of the power converter.

In another embodiment of the invention there is provided a power converter in which the neutralising capacitive element further comprises a dedicated discrete capacitor. This is a relatively simple way of providing the neutralising capacitive element. Alternatively, the neutralising capacitive element further comprises the inter layer capacitance of a PCB. The interlayer capacitance is essentially obtained by having internal planes of a conductive material, preferably copper, on internal adjacent layers. This is also a relatively simple way of providing the neutralising capacitive element.

In one embodiment of the invention there is provided a power converter in which the means to manage common mode noise further comprises a resistive element for tuning the cancellation properties and to limit ringing. Furthermore, the means to manage common mode noise may further comprise an additional series capacitive element for tuning the cancellation properties and to limit ringing. Either the resistive or the capacitive element could be used or indeed, both the resistive and the capacitive elements would be used for tuning the cancellation properties and or damping of ringing that may occur.

In another embodiment of the invention there is provided a power converter in which the sub-converters are interleaved and their outputs are combined to provide an overall converter output. The construction of power converter lends itself to allow the outputs to be connected together in a simple manner that wilt not be expensive to manufacture. This is seen as a cost effective way of providing a more substantial power converter output with a relatively small footprint. By interleaving the power converters, this reduces the ripple currents in both the input and the output stages thereby increasing power density and reducing cost.

In a further embodiment of the invention there is provided a power converter in which there is provided a pre-bias start-up control function comprising means to derive a ramp voltage on start-up. By having a pre-bias start-up control function it is possible to ensure that the current is not drawn from the output during start-up and that the synchronous rectifier elements typically found in such power converters are not turned on until the output is at a value approximately 70% to 100% of the output voltage. A ramp voltage is seen as a particularly simple way to implement this control that is also relatively inexpensive to provide.

In one embodiment of the invention there is provided a power converter in which the means to derive a ramp voltage on start-up further comprises means to charge and monitor the charging of a capacitor. Again, this is a relatively inexpensive way of providing the pre-bias start-up control function.

In another embodiment of the invention there is provided a power converter in which there is provided means to derive the gate drive voltage and the output voltage setting from the ramp voltage. The ramp voltage may be used to provide both the gate drive voltage and the output voltage if desired.

In a further embodiment of the invention there is provided a power converter in which there are provided a pair of ramp slopes, one of which allows for a soft transition of the gate drives for synchronous rectifiers from initially diode mode operation to synchronous rectifier operation. In certain circumstances, the use of one slope to control the start up time and the point of the diode to synchronous rectifier transition mode reduces the flexibility of the circuit to accommodate the sometimes different demands of the two aspects of the design. In general, it is desirable to move from the diode mode to the synchronous rectifier mode as slowly as possible while the power convener applications may place other demands on the required start-up time. This may be satisfied by using a pair of ramp slopes.

### DETAILED DESCRIPTION OF THE INVENTION

The invention will now be more clearly understood from the following description of an embodiment thereof given by way of example only with reference to the accompanying drawings in which;

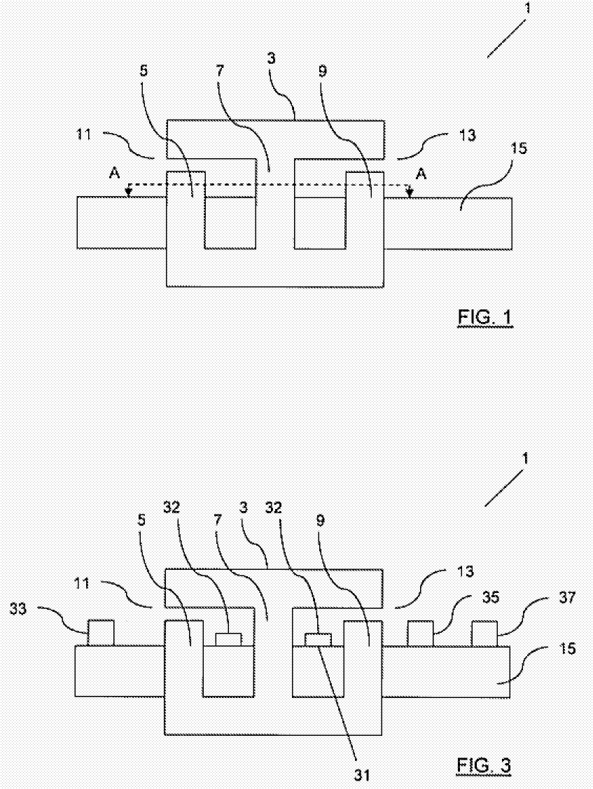

FIG. 1 is a side cross-sectional view of a power converter E-core mounted on a printed circuit board;

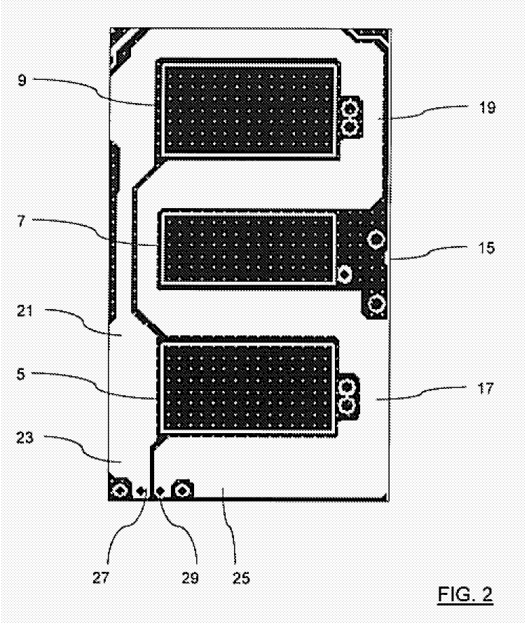

FIG. 2 is a plan cross-sectional view of a primary winding for a converter according to the present invention;

FIG. 3 is a side cross-sectional view of an alternative embodiment of power converter with means to manage common-mode noise;

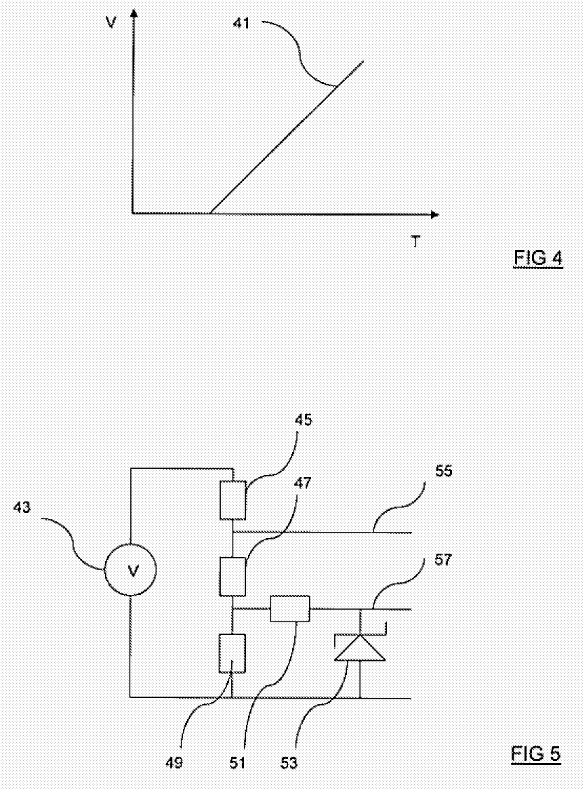

FIG. 4 is a diagrammatic representation of a ramp used for the control of pre-bias operation; and

FIG. 5 is a block diagram of a circuit used for generating the ramp voltage.

Referring to the drawings and initially to FIG. 1 thereof there is shown a power converter indicated generally by the reference numeral 1, comprising a plurality of sub-converters (not shown) and a magnetic core 3. The magnetic core 3 comprises an E-core having a first outer leg 5, an inner leg 7 and a second outer leg 9. Both the first and second outer legs 5, 9 have a gap 11, 13 respectively, formed therein. The magnetic core 3 is mounted on a printed circuit board (PCB) 15 having a plurality of layers (not shown).

Referring to FIG. 2 of the drawings, where like parts have been given the same reference numeral as before, there is shown a plan cross-sectional view of the power converter taken along the lines “A-A” of FIG. 1. The power converter 1 comprises a plurality of sub-converters each having a primary winding 17, 19 and a secondary winding (not shown). The primary winding 17 of a first sub-converter is wound around the first outer leg 5 of the magnetic core 3 and a primary winding 19 of a second sub-converter is wound around the second outer leg 9 of the magnetic core. The pair of primary windings 17, 19 are formed from a unitary winding of conductive material 21. The unitary winding of conductive material 21 forming the pair of primary windings 17, 19, is led around the first outer leg 5 in a first orientation, in this case anti-clockwise, back between the first outer leg 5 and the inner leg 7, around the inner leg 7 in a second orientation (clockwise) opposite to the first orientation, back between the inner leg 7 and the second outer leg 9 and around the second outer leg 9 in the first orientation. Each end 23, 25 of the unitary winding of conductive material 21 terminates in a vias 27, 29 respectively. The vias 27, 29 are located in a corner 30 location of the PCB 15. Therefore, the unitary winding of conductive material 21 forms a single strip of conductive material that follows a labyrinthine route through the legs 5, 7, 9 of the power converter and substantially surrounds both of the outer legs 5, 9.

Referring to FIG. 3 of the drawings, there is shown an alternative embodiment of power converter according to the present invention, where like parts have been given the same reference numerals as before. The power converter 1 further comprises means to manage common-mode noise, which comprises a dummy winding 31 having at least one turn 32 connected to a neutralising capacitive element 33. Preferably, the dummy winding 31 has a number of turns comparable to the number of turns of the primary winding of one of the sub-converters. The turns of the dummy winding 31 are placed around the inner leg 7 of the magnetic core 3. In addition to these components, a resistive element 35 and a capacitive element 37 are mounted on the PCB 15 and are provided for tuning the cancellation properties and/or to limit ringing in the power converter. It will be understood that either or both of the resistive element 35 and the capacitive element 37 may be provided for this purpose. Furthermore, for reasons of clarity, only one turn 32 of the dummy winding 31 has been shown mounted on the surface of the PCB 15 and indeed this turn 32 has been shown exaggerated, protruding upwardly from the surface of the PCB 15 for reasons of clarity and it will be understood that when using planar techniques the turn will in fact be a relatively thin layer of conductive material on a layer of the PCB.

The dummy winding is connected in series with the cancellation capacitance which can be implemented as a discrete part as shown or by utilising the capacitance between copper planes in the PCB. The value of the capacitance can be trimmed or reduced by adding another series element. Alternatively, a resistor can be fitted in series to reduce any tendency for the dummy winding and PCB capacitance to ring at higher frequencies. All elements in the above common-mode noise management circuit may therefore be connected in series.

By having the dummy winding 31 wound around the centre leg 7 a very compact device may be provided that would be well balanced and efficient in use. Furthermore, the dummy winding 31 will not cause to reduce the size of the other windings 17, 19 that are current carrying windings. This is particularly useful as the efficiency of the power converter 1 is not affected adversely. In the embodiments shown the power converter 1 is shown using planar techniques but it will be understood that wire wound techniques could also be used for certain or all of the portions of the invention.

Referring to FIG. 4 of the drawings there is shown a ramp voltage 41 used for control of pre-bias operation in the power converter. The use of pre-bias control ensures that sinking current is not drawn from the output during start-up until the output is running at between 70 to 100% of the required output voltage. The ramp voltage 41 may be derived simply by charging a capacitor (not shown) to provide a suitable approximation of the desired ramp. The desired voltages for the gate drive and the output voltage setting may be derived from the ramp voltage 41.

Referring to FIG. 5 of the drawings there is shown a diagrammatic representation of the circuit schematic for control of the pre-bias operation in the power converter. A voltage source 43, which represents the ramp voltage created using a current source and a capacitor (both of which are not shown for clarity), is provided along with resistive components 45, 47, 49 and 51 as well as zener diode 53. From this circuit, the peak gate drive that is proportional to voltage on line 55, and the output proportional to voltage on line 57, may be obtained. Essentially, we wish to provide a relatively smooth ramp for control of the pre-bias operation as well as provide an inexpensive control circuit. The circuit shown will allow a smooth ramp to be produced at a relatively low cost. Alternatively, it is envisaged that two ramp slopes (not shown), one of which allows for a soft transition of the gate drives of the synchronous rectifier elements (not shown) of the power converter from initially diode mode operation to synchronous rectifier operation could also be provided.

It will be understood that in the embodiments shown above, in addition to providing gaps in the E-core and a continuous inner leg 7, it will be understood that the gap may alternatively be implemented by abutting a separate section, such as a planar section, up against an extended inner leg 7. Furthermore, in the embodiments shown and described above, the power converter 1 has three legs in total including an inner leg 7 and a pair of outer legs 5, 9. It will be understood that this is a particular type of star configuration of a converter magnetic core 3 with two outer legs, which may also be referred to as poles, and an inner leg. Other star configurations with more than two outer legs (poles) could also be provided and indeed are intended to be covered within the scope of this specification and the appended claims. For example, a power converter with a magnetic core having an inner leg and three outer legs (poles), the three outer legs being evenly spaced from the inner leg and evenly spaced from each other symmetrically around the centre leg is also envisaged. In this embodiment, the three outer legs are separated by 120° with respect to each of the other outer legs around the inner leg. Furthermore, it is envisaged that there could be provided a power converter with an X-core, the X-core having an inner leg and four outer legs (poles) evenly spaced from each other symmetrically about the inner leg, separated 90° from adjacent outer legs, and so on and the example with two outer legs has been shown for convenience and illustrative purposes only.

Furthermore, although throughout the description, the windings on the outer legs have been described as separate sub-converters, it will be understood that typically, these sub-converters are not entirely separate and in fact are interleaved and in a normal embodiment the outputs of the sub-converters will be combined together for a single power converter output. The components have been described in this instance as sub-converters for reasons of convenience and clarity.

In this specification the terms “comprise”, “comprises”, “comprised” and “comprising” are deemed totally interchangeable and the terms “include”, “includes”, “included” and “including” are deemed totally interchangeable and should be afforded the widest possible interpretation.

The invention is in no way limited to the embodiments hereinbefore described but may be varied in both construction and detail within the scope of the claims.

1. A power converter (1) comprising a plurality of sub-converters and a magnetic core (3), the plurality of sub-converters each having a primary winding (17, 19) and a secondary winding, the magnetic core (3) further comprising an inner leg (7) and a plurality of outer legs (5, 9), each of the plurality of outer legs (5, 9) having a gap (11, 13) formed therein, characterised in that the primary winding (17) of one of the sub-converters is wound around one of the outer legs (5) and the primary winding (19) of another sub-converter is wound around another of the outer legs (9), the primary windings (17, 19) being formed from a unitary winding of conductive material (21).

2. A power converter (1) as claimed in claim 1 in which the primary windings (17, 19) of a plurality of the sub-converters each comprise a plurality of turns, each turn of one of the sub-converters being formed from a unitary winding of conductive material (21) with a corresponding turn of another sub-converter, each turn of the sub-converter being connected to another turn of that sub-converter by way of an interconnect, thereby connecting the primary windings of the pair of sub-converters in series on a turn-by-turn basis.

3. A power converter (1) as claimed in claim 1 in which the power converter further comprises a printed circuit board (PCB) (15) and the primary windings are constructed using planar techniques.

4. A power converter (1) as claimed in claim 3 in which each end (23, 25) of the unitary winding of conductive material (21) terminates in a vias (27, 29).

5. A power converter (1) as claimed in claim 4 in which the vias (27, 29) are located in a corner location of the PCB (15).

6. A power converter (1) as claimed in claim 1 in which the magnetic core (3) further comprises an E-core having a first outer leg (5), an inner leg (7) and a second outer leg (9).

7. A power converter (1) as claimed in claim 6 in which the unitary winding of conductive material (21) is led around the first outer leg (5) in a first orientation, back between the first outer leg (5) and the inner leg (7), around the inner leg (7) in the opposite orientation to the first orientation, back between the inner leg (7) and the second outer leg (9) and around the second outer leg (9) in the first orientation.

8. A power converter (1) as claimed in claim 7 in which the unitary winding of conductive material (21) substantially surrounds each of the outer legs (5, 9).

9. A power converter (1) as claimed in claim 1 in which the magnetic core (3) further comprises a star configuration core in which there are provided three or more outer legs and an inner leg (7), the outer legs being evenly spaced from the inner leg and symmetrically spaced around the inner leg with respect to each other.

10. A power converter (1) as claimed in claim 9 in which the unitary winding of conductive material (21) is wound around each of the outer legs and the inner leg (7), the unitary winding being wound at least partially around the inner leg between being wound around a pair of outer legs.

11. A power converter (1) as claimed in claim 10 in which the unitary winding of conductive material (21) substantially surrounds each of the outer legs.

12. A power converter (1) as claimed in claim 1 in which the power converter is further provided with means to manage common-mode noise, the means comprising a dummy winding (31) having at least one turn (32), the turn being connected to a neutralising capacitive element (33).

13. A power converter (1) as claimed in claim 12 in which the dummy winding (31) has a number of turns (32) comparable to the number of turns of the primary winding (17, 19) of a sub-converter of the power converter.

14. A power converter (1) as claimed in claim 12 in which the turn (32) of the dummy winding (31) is placed around the inner leg (7) of the magnetic core (3).

15. A power converter (1) as claimed in claim 12 in which the neutralising capacitive element further comprises a dedicated discrete capacitor.

16. A power converter (1) as claimed in claim 12 in which the neutralising capacitive element further comprises the interlayer capacitance of a PCB.

17. A power converter (1) as claimed in claim 12 in which the means to manage common mode noise further comprises a resistive element (35) for tuning the cancellation properties and to limit ringing.

18. A power converter (1) as claimed in claim 12 in which the means to manage common mode noise further comprises an additional series capacitive element (37) for tuning the cancellation properties and to limit ringing.

19. A power converter (1) as claimed in claim 1 in which the sub-converters are interleaved and their outputs are combined to provide an overall converter output.

20. A power converter (1) as claimed in claim 1 in which there is provided a pre-bias start-up control function comprising means (33, 35, 37, 39, 41, 43) to derive a ramp voltage on start-up.

21. A power converter (1) as claimed in claim 20 in which the means to derive a ramp voltage on start-up further comprises means to charge and monitor the charging of a capacitor.

22. A power converter (1) as claimed in claim 20 in which there is provided means to derive the gate drive voltage and the output voltage setting from the ramp voltage.

23. A power converter (1) as claimed in claim 20 in which there are provided a pair of ramp slopes, one of which allows for a soft transition of the gate drives for synchronous rectifiers from initially diode mode operation to synchronous rectifier operation.
